(19) United States
(12) Patent Application Publication
(10) Pub. No.: US 2010/0034168 A1
(43) Pub. Date: Feb. 11, 2010

(54) System and Method for Enabling SR-VCC with Shared IMPU

(76) Inventor: Kaniz Mahdi, Carrollton, TX (US)

Correspondence Address: Slater & Matsil, L.L.P., 17950 Preston Road, Suite 1000, Dallas, TX, 75252, US

(21) Appl. No.: 12/511,609

(22) Filed: Jul. 29, 2009

Related U.S. Application Data
(60) Provisional application No. 61/087,362, filed on Aug. 8, 2008.

(51) Int. Cl. H04W 36/00; H04L 12/66

(52) U.S. Cl. 370/331; 370/352

(57) ABSTRACT

Embodiments of the present invention provide a system and method for identification of a UE for session transfer requests initiated by an MSC Server using a GRUU. The UE provides the GRUU to an MME upon IMS Registration, and the MME provides the GRUU to the MSC Server as part of a handover request. The MSC Server may use an Mg or Mw SIP interface, or an ISUP interface to initiate a session transfer. If the MSC Server has an Mg or Mw SIP interface, the GRUU is asserted in a SIP message, e.g., an INVITE message, sent to initiate session transfer. If the MSC Server does not have the SIP interface, i.e., uses ISUP to initiate session transfer, then the GRUU is passed via a gsmSCF into an SCC AS. The SCC AS uses the GRUU to identify the UE for which the session transfer request is being initiated.

This application claims the benefit of U.S. Provisional Application No. 61/087,362, filed on Aug. 8, 2008, entitled “System and Method for Enabling SR-VCC with Shared IMPU,” which application is hereby incorporated herein by reference.

### TECHNICAL FIELD

The present invention relates generally to telecommunications, and more particularly, to a system and method for enablement of Single Radio-Voice Call Continuity (SR-VCC) transfers when more than one User Equipment (UE) shares a same IP Multimedia Public Identity (IMPU).

### BACKGROUND

IP Multimedia Subsystem (IMS) is an architectural framework for delivering Internet Protocol (IP) multimedia to mobile users. IMS is designed to deliver integrated multimedia services and create an open, standard-based network.

IMS Centralized Services is an approach to the provision of communication services wherein services and service control are based on IMS mechanisms and enablers, and support is provided for a diversity of access networks (including circuit switched and IP based, wireless and wireline). Service continuity between domains, e.g., the circuit-switch (CS) domain and the packet-switch (PS) domain, is also provided.

VCC is a key aspect of the IMS, allowing a UE to move between different network access technologies while maintaining a consistent user experience. To handle SR-VCC it was proposed that a session transfer request initiated by a Mobile Switching Center (MSC) Server identify the request using an IMPU, such as a Mobile Subscriber Integrated Services Digital Network Number (MSISDN). The IMPU (and the MSISDN), however, may be shared between multiple UEs simultaneously engaged in IMS sessions. Generally, the IMPU identifies a user, rather than a device.

In the situation in which a user currently has a single session established on a single UE, the use of the IMPU is sufficient to allow a user to efficiently and accurately transfer the session from, for example, the PS domain to the CS domain because there is only one active session and only one active UE. In the situation in which the user has multiple sessions instantiated on a single UE or on different UE, however, the user is unable to identify which UE is to be handed over from the PS domain to the CS domain, because the IMPU identifies the user and the user has multiple active sessions and/or UEs. Thus, what is needed is a system and method for identifying the UE for session transfer requests initiated by the MSC Server enhanced with SR-VCC.

### SUMMARY OF THE INVENTION

These and other problems are generally solved or circumvented, and technical advantages are generally achieved, by preferred embodiments of the present invention which provides for systems and methods of identifying a User Equipment (UE) for session transfers.

Embodiments of the present invention provide systems, methods, and apparatuses for identification of a UE for session transfer requests initiated by a Mobile Switching Center (MSC) Server enhanced with Single Radio-Voice Call Continuity (SR-VCC) by using a UE identifier, such as a Globally Routable User Agent (UA) Uniform Resource Identifier (URI) (GRUU). Generally, the UE provides the Mobility Management Entity (MME) in the packet-switch (PS) domain with the GRUU upon IP Multimedia Subsystem (IMS) registration procedures. In an embodiment, the UE provides the MME with the GRUU during the IMS registration procedure and the MME provides the GRUU to the MSC Server as part of handover request.

In an embodiment in which the MSC Server has an Mg or Mw Session Initiation Protocol (SIP) interface, the GRUU is inserted in a message, e.g., the INVITE message, sent to initiate session transfer to a Service Centralization Continuity Application Server (SCC AS). In another embodiment in which the MSC Server does not have the SIP interface, e.g., the MSC Server uses ISDN User Part (ISUP) to initiate the session transfer request, the GRUU is passed via a gsmSCF into a SCC AS. The SCC AS uses the GRUU to identify the UE for which the session transfer request is being initiated.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 illustrates a functional architecture diagram in accordance with an embodiment of the present invention;

FIG. 2 illustrates a functional architecture diagram with signaling and bearer paths using SIP messaging in accordance with an embodiment of the present invention;

FIG. 3 is a message flow diagram illustrating transfer of a session from the PS domain to the CS domain using SIP messaging in accordance with an embodiment of the present invention;

FIG. 4 illustrates a functional architecture diagram with signaling and bearer paths using ISUP messaging in accordance with another embodiment of the present invention;

FIG. 5 is a message flow diagram illustrating transfer of a session from the PS domain to the CS domain using ISUP messaging in accordance with an embodiment of the present invention; and

FIG. 6 is a block diagram of a network element in accordance with an embodiment of the present invention.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed herein are merely illustrative of specific ways to make and use the invention, and do not limit the scope of the invention.

Embodiments of the present invention provide systems and methods for identification of a User Equipment (UE) for session transfer requests during handover initiated by a Mobile Switching Center (MSC) Server enhanced with Single Radio-Voice Call Continuity (SR-VCC) by using an identifier that uniquely identifies the UE, such as a Globally Routable User Agent (UA) Uniform Resource Identifier (URI) (GRUU). The embodiments disclosed herein have an advantage that there is minimal impact to network entities already being enhanced for SR-VCC and little or no impact imposed on the Home Subscriber Server (HSS) or the Sh interface.

Embodiments of the present invention discussed herein are described in the context of performing a handover request from one access point to another access point, such as handing over from the Packet Switch (PS) domain to the Circuit Switch (CS) domain. These embodiments disclosed herein also assume the use of a 3G-4G dual-mode UE. One of ordinary skill in the art will realize that other embodiments of the present invention may be applied to other situations as well as different networks, such as ad hoc networks, cellular networks, wireline networks, and the like, as well as other architectural configurations.

As discussed in greater detail below, an embodiment of the present invention includes the UE providing the Mobility Management Entity (MME) with the GRUU during the IP Multimedia Subsystem (IMS) registration procedure, wherein the MME forwards the GRUU to the MSC Server upon handover request. If the MSC Server has an Mg or Mw Session Initiation Protocol (SIP) interface, the GRUU is inserted in a message, e.g., the INVITE message, sent to initiate a session transfer. If the MSC Server does not have an SIP interface, e.g., the MSC Server uses ISDN User Part (ISUP) to initiate session transfer request, then the GRUU is passed via a gsmSCF into a Service Centralization Continuity Application Server (SCC AS). The SCC AS uses the GRUU to identify the UE for which the session transfer request is being initiated

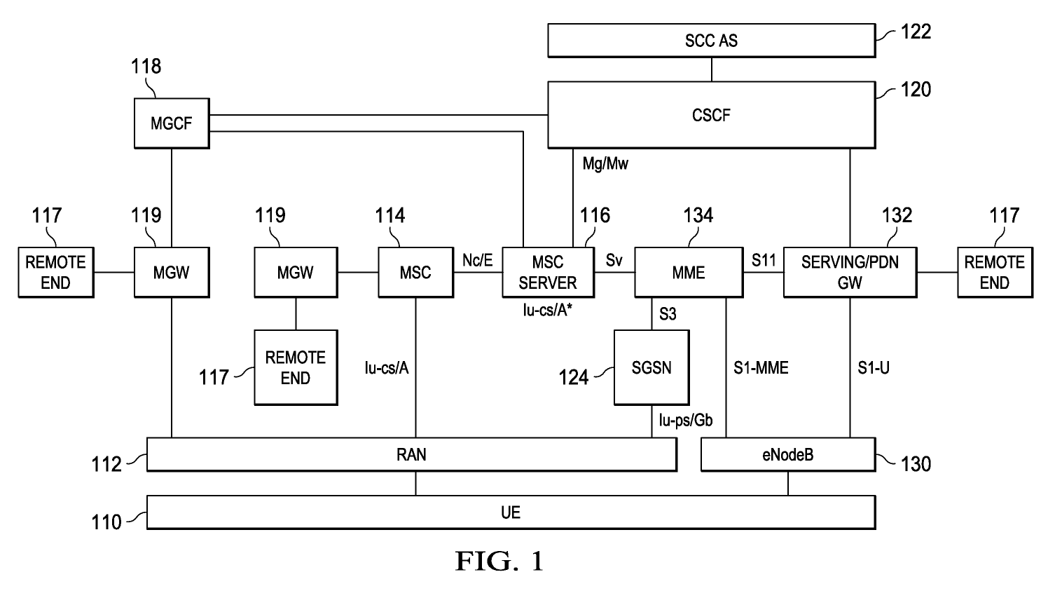

Referring now to FIG. 1, there is shown an architecture diagram in accordance with an embodiment of the present invention. A UE 110 comprises a user device and may include any type of device providing voice and/or data access, such as a wireless phone, computer, personal data assistant (PDA), or the like, via a CS communications path. In an embodiment, the UE 110 is a dual-mode 3G/4G device capable of communicating via packet-switched communications and/or circuit-switched communications.

Generally, the UE 110 connects via a Radio Access Network (RAN) 112, such as a GSM EDGE RAN (GERAN) and/or a UMTS Terrestrial RAN (UTRAN), which provides access and wireless CS connectivity services to the CS core network and PS connectivity services to the IMS network (a PS-based network). In the CS domain, the RAN 112 is communicatively coupled to an MSC 114 and an MSC Server 116. The MSC 114 is responsible for handling voice calls as well as CS data services for the UE 110 when operating in a CS mode. The MSC Server 116 operates in conjunction with the MSC 114 to provide mobility management. The MSC 114 is further coupled to a Media Gateway Control Function (MGCF) 118, which acts as a gateway between SIP-based and ISUP-based systems, performing call control protocol conversion. As such, the MGCF 118 also interfaces with a Call Session Control Function (CSCF) 120 and possibly an SCC AS 122, or other application servers, which collectively provide IMS services. The MGCF 118 and the MSC 114 may be connected to a Media Gateway (MGW) 119, which provides a connection towards a remote end 117.

As discussed in greater detail below, the MSC Server 116 may also be communicatively coupled to the CSCF 120 via the Mg/Mw interfaces for call control purposes. The Mg/Mw interfaces provide a SIP interface directly to the CSCF 120.

In the situation in which the UE 110 is operating in a 3G mode using PS communications, the RAN 112 communicates with a Serving General Packet Radio Service (GPRS) Support Node (SGSN) 124. The SGSN 124, among other things, aids in delivery of data packets to/from the UE 110.

As one of ordinary skill in the art will appreciate, the above architecture describes some of the features of a 2G/3G network. Also shown in FIG. 1, are elements of a 4G network. Namely, when operating in a 4G mode, the UE 110 connects via an eNodeB 130, sometimes referred to as an evolved Universal Terrestrial Radio Access Network (eUTRAN), which provides a packet-based wireless access point. The eNodeB 130 connects to a Serving Packet Data Network (PDN) Gateway (GW) 132, which in turn provides a connection towards the remote end 117. The eNodeB 130 is also connected to an MME 134 within the 4G network, wherein the MME 134 provides mobility functionality for the UE 110.

It should be noted that other network elements, such as routers, gateways, switches, and/or the like, may be present within the network. The configurations and the communications between network elements as they are relevant to embodiments of the present invention are provided for illustrative purposes only to provide a better understanding of the present invention. As such, the communications between the specified elements may be between different elements and/or through additional elements and different signaling/commands may be used.

As discussed in greater detail in the following paragraphs, the general principles of the present invention may be applied to various scenarios. It should be noted that the following embodiments are provided for illustrative purposes only and are not intended to limit the scope of the present invention to only those embodiments described herein. Furthermore, it should be noted that the messages and the message parameters are provided for illustrative purposes only and that other messages and parameters may be used, as well as any suitable protocol, such as session description protocol (SDP), SIP, or the like. Additional information regarding the various network elements, interfaces, and message flows may be found in 3GPP TS 23.228, v9.0.0 and 3GPP TS 23.237, v9.1.0, which are incorporated herein by reference.

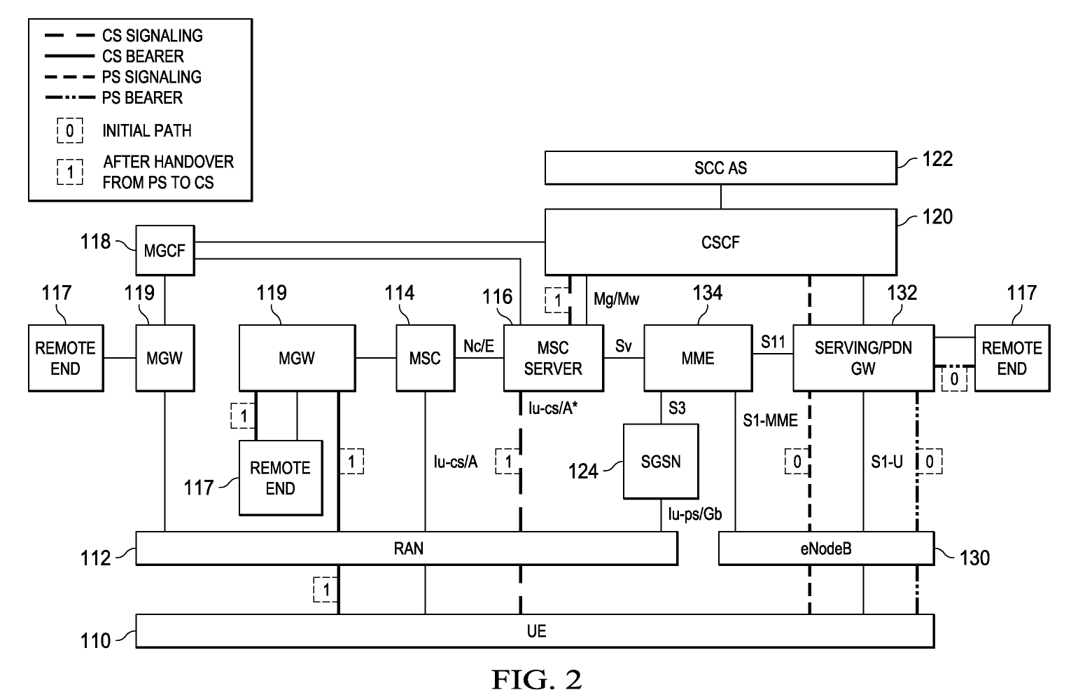

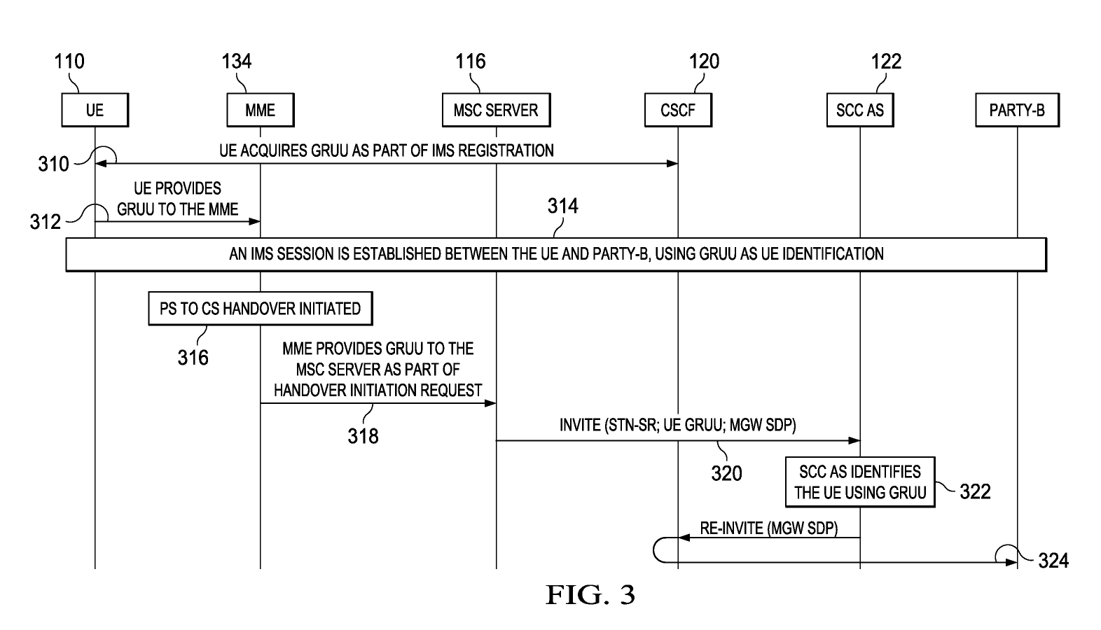

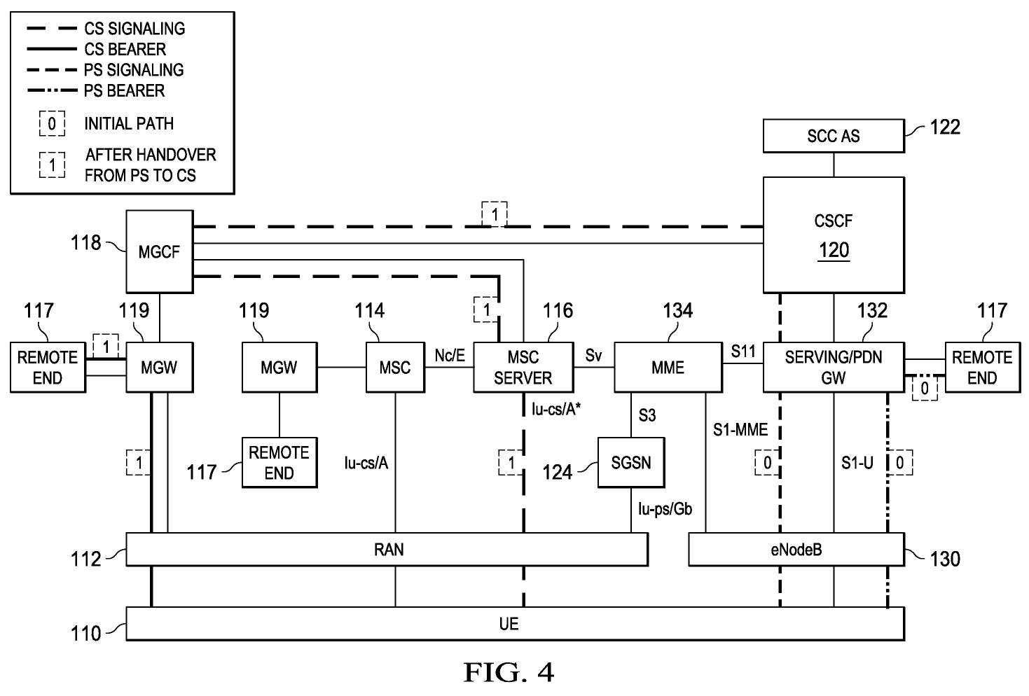

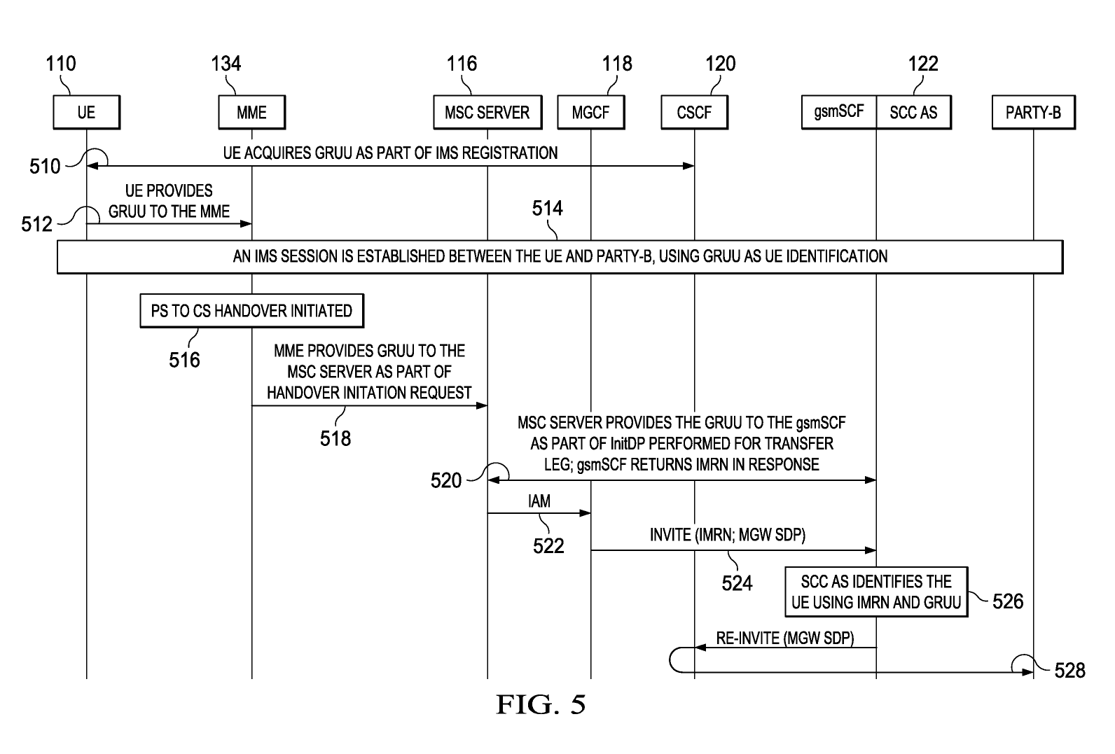

As discussed above, an embodiment of the present invention utilizes the Mg/Mw interface, which is known in the art, for transferring a session using the GRUU to identify the UE 110. This embodiment is further detailed below with reference to FIGS. 2 and 3. FIGS. 4 and 5 illustrate another embodiment in which the MSC Server uses ISUP with the GRUU to identify the UE 110 for the purpose of transferring a session.

Referring now to FIG. 2, the system architecture diagram with the signaling and bearer paths shown before and after session transfer is shown in accordance with an embodiment of the present invention. Boxes with reference numeral 0 represent the signaling and bearer channels prior to session transfer while the UE 110 is communicating via the 4G system, e.g., via the eNodeB 130. As illustrated in FIG. 2, the PS signaling channel extends between the UE 110, the eNodeB 130, the Serving PDN GW 132, and the CSCF 120. The PS bearer channel extends between the UE 110, the eNodeB 130, and the Serving PDN GW 132, which directs the bearer traffic to/from the remote end 117.

Boxes with reference numeral 1 represent the signaling and bearer channels after the session transfer has been completed. In this case, the signaling and bearer channels are in the CS domain, wherein the CS signaling extends between the UE 110, the RAN 112, the MSC Server 116, and the CSCF 120. The CS bearer channel after session transfer extends between the UE 110, the RAN 112, and the MGW 119, which directs bearer traffic to/from the remote end 117.

As one of ordinary skill in the art will appreciate, this embodiment utilizes the Mg/Mw interface between the MSC Server 116 and the CSCF 120 to communicate mobility information. In particular, as discussed in greater detail below, the Mg/Mw interface is utilized to transmit a message including an identifier that identifies the UE 110 upon detecting that a transfer or handover is desired.

FIG. 3 is a message flow diagram that further illustrates a handover procedure in which a session is handed over from the 4G network to the 3G network in accordance with an embodiment of the present invention. As indicated by reference numeral 310, the UE 110 acquires an Instance-ID as part of the IMS registration procedures as is known in the art. In an embodiment, the Instance-ID is the GRUU assigned to the ULE 110, wherein the GRUU uniquely identifies the UE 110. As one of ordinary skill in the art will appreciate, the GRUU is used in the PS IMS system to identify the UE 110. Embodiments of the present invention extend this feature to utilize the GRUU in the CS domain as well as the PS IMS domain, thereby providing greater session/service continuity between the PS domain and the CS domain.

Upon IMS registration, the UE 110 in step 312 provides the GRUU (or other Instance-ID or other UE identifier) to the MME 134. As one of ordinary skill in the art will realize, the MME 134 is aware of the user ID, which identifies the user, and the session ID, which identifies the session. The addition of the GRUU in accordance with embodiments of the present invention in combination with the user ID and the session ID allows each media flow to each UE 110 to be uniquely identified, thereby allowing the system to determine the specific media flow that is to be transferred. At this point, an IMS session is established between the UE 110 and the remote end, e.g., Party-B, as illustrated in step 314 in FIG. 3.

In step 316, radio measurements between the UE 110 and the RAN 112/eNodeB 130 trigger a handover procedure from the PS domain to the CS domain. Accordingly, in step 318, the MME 134 provides the GRUU to the MSC Server 116 as part of a Handover Request. By doing so, the GRUU is shared between the PS IMS domain (the MME 134) and the CS domain (the MSC Server 116). The MSC Server 116 provides the GRUU to the CSCF 120 via the Mg/Mw SIP interface using, for example, a SIP INVITE message in step 320. The SIP INVITE message may include as parameters, in addition to the GRUU, a Session Transfer Number for Single Radio (STN-SR) that identifies the session and an MGW Session Description Protocol (SDP) parameter that identifies the media port on the GW. The CSCF 120 forwards the SIP INVITE message to the SCC AS 122.

In step 322, the SCC AS 122 receives the SIP INVITE message containing the GRUU and uses the GRUU to identify the UE 110. The SCC AS 122 compares the GRUU received from the CS domain via the MSC Server 116 (via the CSCF 120) with the GRUUs received from the PS domain. Once located, the SCC AS 122 initiates transfer of only the media flow or media flows associated with the specified GRUU. Any other media flows and/or sessions associated with the user, but being directed toward a different UE, are not transferred. The SCC AS 122 may obtain the GRUU from the PS domain at the time the UE requests IMS registration. In an embodiment, the SCC AS 122 performs a third-party registration procedure, which allows it to receive a copy of IMS Registration (with sub-set of information) from CSCF 120 when the UE performs IMS Registration.

The transfer is initiated by the SCC AS 122 transmitting, for example, a SIP Re-INVITE message having the MGW SDP as a parameter, as indicated in step 324.

FIG. 4 illustrates the system architecture diagram with the signaling and bearer paths shown before and after session transfer is shown in accordance with another embodiment of the present invention. Boxes with reference numeral 0 represent the signaling and bearer channels prior to session transfer while the UE 110 is communicating via the 4G system, e.g., via the eNodeB 130. As illustrated in FIG. 4, the PS signaling channel extends between the UE 110, the eNodeB 130, the Serving PDN GW 132, and the CSCF 120. The PS bearer channel extends between the UE 110, the eNodeB 130, and the Serving PDN GW 132, which directs the bearer traffic to/from the remote end 117.

Boxes with reference numeral 1 represent the signaling and bearer channels after the session transfer has been completed. While the signaling and bearer channels in the PS domain are similar in FIGS. 2 and 4, the signaling and bearer channels in the CS domain are different in this embodiment. The CS signaling extends between the UE 110, the RAN 112, the MSC Server 116, the MGCF 118, and the CSCF 120. In contrast to the embodiment illustrated in FIG. 2, the Mg/Mw interface extending between the MSC Server 116 and the CSCF 120 is not available in the embodiment illustrated in FIG. 4. As a result, the MGCF 118 facilitates the CS signaling between the MSC Server 116 and the CSCF 120 using ISUP signaling.

FIG. 5 is a message flow diagram that illustrates a handover procedure in which a session is handed over from the 4G network to the 3G network in accordance with the embodiment illustrated in FIG. 4. Steps 510-518 are similar to steps 310-318, respectively, and will not be further discussed.

In step 520, messages are exchanged between the MSC Server 116 and a GSM Service Control Function (gsmSCF)/SCC AS. Generally, the gsmSCF is a service control point (SCP) that provides call processing control functions for GSM devices in a Customized Applications for Mobile Network Enhanced Logic (CAMEL) network. For the purposes of this discussion, the gsmSCF is illustrated as being part of the SCC AS 122, although one of ordinary skill in the art will realize that the gsmSCF may be a separate element in the network positioned with a communication path with the SCC AS 122. In an embodiment, the MSC Server 116 provides the GRUU to the gsmSCF as part of an InitDP message using CAMEL Application Part (CAP). In response, the gsmSCF returns the IP Multimedia Routing Number (IMRN) using CAP.

In step 522, the MSC Server 116 transmits an Initial Address Message (IAM) to the MGCF 118 with the IMRN as a parameter. Thereafter, in step 524, the MGCF 118 transmits an SIP INVITE message with the IMRN and the MGW SDP as parameters. The MGCF 118 forwards the SIP INVITE message to the SCC AS 122.

In step 526, the SCC AS 122 receives the SIP INVITE message containing the IMRN. The IMRN includes a call reference number that can be used to access the call data stored in the gsmSCF. The SCC AS 122 provides this call reference number to the gsmSCF to retrieve the GRUU along with other data related to the session that is being transferred. The SCC AS 122 uses the GRUU to identify the UE and to identify the specific sessions/media flows associated with that UE. Once located, the SCC AS 122 initiates transfer of only the media flow or media flows associated with the specific UE identified by the IMRN and the GRUU. Any other media flows and/or sessions associated with the user, but being directed toward a different UE, are not transferred.

The transfer is initiated by the SCC AS 122 by transmitting, for example, a SIP Re-INVITE message having the MGW SDP as a parameter, as indicated in step 528.

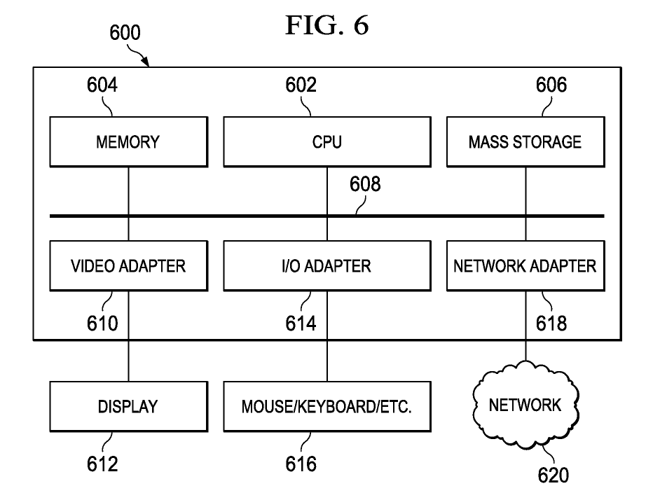

Referring now to FIG. 6, a block diagram of a network element 600 is provided in accordance with an embodiment of the present invention. The network element 600 depicts a general purpose platform and the general components and functionality that may be used to implement any or all of the UE 110, the SCC AS 122, CSCF 120, eNodeB 130, MME 134, MSC 114, MSC Server 116, MGCF 118, and/or the like. The network element 600 may include, for example, a central processing unit (CPU) 602, memory 604, and a mass storage device 606 connected to a bus 608 configured to perform the processes discussed above. The network element 600 may further include, if desired or needed, a video adapter 610 to provide connectivity to a local display 612 and an I/O adapter 614 to provide an input/output interface for one or more input/output devices 616, such as a mouse, a keyboard, printer, tape drive, CD drive, or the like.

The network element 600 also includes a network interface 618, which may be a wired link, such as an Ethernet cable or the like, and/or a wireless/cellular link, that provides a connection to network 620. In an embodiment, the network adapter 618 comprises a switching fabric for switching bearer and signaling channels. The network adapter 618 may also comprise a suitable receiver and transmitter for wireless communications. It should be noted that the network element 600 may include other components. For example, the network element 600 may include power supplies, cables, a motherboard, removable storage media, cases, and the like. These other components, although not shown, are considered part of the network element 600.

Although the present invention and its advantages have been described in detail, it should be understood that various changes, substitutions and alterations can be made herein without departing from the spirit and scope of the invention as defined by the appended claims. For example, many of the features and functions discussed above can be implemented in software, hardware, or firmware, or a combination thereof. As another example, it will be readily understood by those skilled in the art that different network elements, messaging, protocols, and/or the like may be varied while remaining within the scope of the present invention.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method of transferring a media flow from a packet-switch (PS) domain to a circuit-switch (CS) domain, the method comprising:
acquiring by a User Equipment (UE) a UE identifier that uniquely identifies the UE;
providing by the PS domain the UE identifier to the CS domain;
transmitting a handover initiation request, the handover initiation request including the UE identifier; and
transferring one or more media flows attached to the UE from the PS domain to the CS domain.

2. The method of claim 1, wherein the UE acquires the UE identifier during an IP Multimedia Subsystem (IMS) registration procedure.

3. The method of claim 1, wherein the UE identifier is a Globally Routable User Agent (UA) Uniform Resource Identifier (GRUU).

4. The method of claim 1, wherein the UE identifier is provided to the CS domain as part of the handover initiation request.

5. The method of claim 1, further comprising providing by the UE the UE identifier to a mobility manager in the PS domain.

6. The method of claim 5, wherein the mobility manager is a Mobility Management Entity (MME).

7. The method of claim 1, wherein the transmitting is performed by a Mobile Switching Center (MSC) Server.

8. The method of claim 1, wherein the transmitting is performed via Session Initiation Protocol (SIP) message.

9. The method of claim 8, wherein the SIP message is transmitted via an Mg/Mw interface.

10. The method of claim 1, wherein the transmitting is performed via an ISDN User Part (ISUP) message.

11. The method of claim 1, wherein the transmitting is performed via a Media Gateway Control Function (MGCF).

12. A system for identification of a UE for session transfer requests from a packet-switch (PS) domain to a circuit-switch (CS) domain, the system comprising:
a User Equipment (UE) having a UE identifier acquired as part of an IP Multimedia Subsystem (IMS) Registration;
a first PS network element in the PS domain, the first network element configured to receive from the UE the UE identifier; and
a first CS network element in the CS domain configured to receive the UE identifier from the first PS network element in the PS domain and to provide the UE identifier for handover of media flows associated with the UE from the PS domain to the CS domain.

13. The system of claim 12, wherein the UE identifier is a Globally Routable User Agent (UA) Uniform Resource Identifier (GRUU).

14. The system of claim 12, wherein the first CS network element has a Session Initiation Protocol (SIP) interface, wherein the first CS network element is configured to provide the UE identifier via the SIP interface.

15. The system of claim 14, wherein the first CS network element provides the UE identifier in a SIP INVITE message sent to initiate a Session Transfer.

16. The system of claim 14, wherein the SIP interface is an Mg SIP interface or an Mw SIP interface.

17. The system of claim 12, wherein the first CS network element provides the UE identifier in an ISDN User Part (ISUP) message.

18. The system of claim 12, further comprising a GSM Service Control Function (gsmSCF) communicatively coupled to the first CS network element, the first CS network element providing the gsmSCF the UE identifier.

19. The system of claim 12, further comprising:
a Service Centralization Continuity Application Server (SCC AS), wherein the SCC AS uses the UE identifier to identify the UE for which the session transfer request is being initiated.

20. The system in claim 12, wherein the first CS network element is a Mobile Switching Center (MSC) Server.

21. A Mobile Switching Center (MSC) Server comprising:
a first network interface communicatively coupled to a packet-switch (PS) domain network element;
a second network interface communicatively coupled to a circuit-switch (CS) domain network element; and
a processing unit configured to receive a user equipment (UE) identifier over the first network interface and to transmit the UE identifier over the second network interface in response to a handover request.

22. The MSC Server of claim 21, wherein the UE identifier is a Globally Routable User Agent (UA) Uniform Resource Identifier (GRUU).

23. The MSC Server of claim 21, wherein the second network interface is a Session Initiation Protocol (SIP) interface.

24. The MSC Server of claim 23, wherein the SIP interface is an Mg SIP interface or an Mw SIP interface.

25. The MSC Server of claim 21, wherein the second network interface is an ISDN User Part (ISUP) interface.
